(19) United States
(12) Patent Application Publication
(10) Pub. No.: US 2014/0077423 A1
(43) Pub. Date: Mar. 20, 2014

(54) METHOD AND DEVICE FOR INSERTING CORES OF ROVINGS INTO A PRESS

(71) Applicant: Robert Burkle GmbH, Freudenstadt (DE)

(72) Inventor: Martin Brummerstadt, Alpirsbach (DE)

(21) Appl. No.: 14/017,596

(22) Filed: Sep. 4, 2013

(30) Foreign Application Priority Data
Sep. 4, 2012 (DE) 102012215688.7

(51) Int. Cl. B29C 43/00

(52) U.S. Cl. CPC B29C 43/003
USPC 264/517; 425/389

(57) ABSTRACT

A method for inserting cores of rovings (2) into a press, in which fiber composite parts are produced, with the core being accepted by a removal tool (11, 12, 13), moved over a bottom (14) of a press, and placed here. The placement of the core on the bottom (14) of the press occurs with the help of an elastic membrane (12) arranged at the removal tool. A removal tool is also provided.

### INCORPORATION BY REFERENCE

The following documents are incorporated herein by reference as if fully set froth: German Patent Application No. 102012215688.7, filed Sep. 4, 2012.

### BACKGROUND

The invention relates to a method for inserting cores of rovings into a press, in which fiber composite parts are produced, as well as a removing tool for executing such a method.

Rovings are bundles of continuous fibers and/or filaments, which are used for producing fiber composite materials. Here individual filaments made from glass, ceramics, aramid, and the like are used, particularly however carbon fibers. Rovings comprising carbon fibers are made from up to several thousand filaments and are frequently processed in the form of tapes. Within the scope of the present invention additionally such roving tapes are called “roving”, which strictly speaking comprise several combined rovings, as well as bundles of rovings or roving tapes.

In order to produce fiber composite parts from rovings, the rovings first need to be placed such that they form a core comprising at least one core layer. A fiber composite material essentially comprises two primary components, the rovings and a matrix in which it is embedded. A primary field of application of the present invention is the production of carbon-fiber reinforced plastics (CFK), which due to their resilience and their low weight increasingly replace materials comprising steel or aluminum, in particular in vehicle construction, however also in stationary technical applications with mobile parts, such as wind turbines. In addition to carbon fibers, which generally were produced from polyacrylonitrile as the primary substance and comprise up to 95% pure carbon, here epoxy resins and thermoplastics are used for the matrix.

The strength properties of fiber composite materials decisively depend on the orientation of the rovings extending therein. Due to the fact that the rovings embedded in the matrix show high tensile strength, here during the embedding of rovings in only one spatial direction, for example, a unidirectional resilience of fiber composite parts develops. The mechanic features are usually poor perpendicular in reference to the direction of the fibers of the rovings. In order to produce fiber composite parts with useful features the rovings are therefore usually placed such that they extend aligned at least in two spatial directions. In particular for the automated production of plastics reinforced with carbon fibers (CFK) the rovings are usually woven or meshed so that they are present as a planar core layer to be embedded in the matrix, with the rovings in this core layer being aligned perpendicular in reference to each other. An example for a respective method is discernible from DE 100 05 202 A1. An alternative production method for fiber composite materials is given in fiber guniting, in which the short roving sections are embedded in a matrix according to statistically distributed spatial directions. The resilience of such fiber composite materials is not optimal, though, because the features of the rovings are considerably worsened by cutting.

Particularly in vehicle construction it is desirable, though, to produce three-dimensionally shaped parts from CFK-materials. Furthermore, these parts frequently must meet very specific strength properties, so that the orientation of the rovings embedded in the matrix should be aligned accordingly. Here, woven or meshed cores are frequently not optimal. A fiber composite material produced in fiber guniting can fulfill the respective requirements to an even lesser extent due to its nature. In aircrafts as well as bicycles and in motor sports accordingly fiber composite parts are used, particularly made from CFK, with here rovings are manually placed for their production. This way the orientation of the rovings can be embodied optimally, however such a manual production is naturally very costly. Any large scale serial production, particularly in automotive production, is impossible with manually placed rovings, though.

In order to place rovings in a desired density and alignment, which depend on the desired mechanic properties of the finished parts, in an automatic fashion to form a core it is known in prior art to guide at least one roving over a number of pin elements, at which the roving is respectively deflected in order to form a planar core layer, if possible showing multiple axial alignments. Here and generally within the present invention, pin elements shall be understood as any elements, around which the roving can be deflected; thus it is not required for them to represent pins in the sense of the word. Examples for a method for the automatic placement of rovings over a plurality of pin elements are discernible from EP-A-0 591 822 and EP-A-0 110 698.

The core comprising rovings and serving as a semi-finished product finally must be embedded in the matrix in order to allow producing the desired fiber composite part. The present invention is here based on prior art, in which the core of rovings as well as the source material for the matrix are inserted into a laminating press, in which the source material for the matrix is molten and/or activated under pressure and heat and the bonding with the rovings is generated. The source material for the matrix can here be spread inside or outside the press onto the core or between several layers of said core or be applied in the form of a film; however it is also possible to use rovings which have already been soaked with matrix material.

The production of the fiber composite part in a laminating press offers the considerable advantage that most different three-dimensional shapes of parts can be produced. For example, the press bottom, upon which the core and the matrix material is placed, may form a negative of the desired surface of the part, with the core abutting it during the pressing process. The top of the press may comprise an elastic press membrane as a compression element, which then by the introduction of compression fluid into a compression chamber located above the press membrane and/or by evacuating the space between the bottom of the press and the press membrane itself causes the core to adapt and presses it into the form of the bottom of the press. Membrane presses for laminating parts are known per se and for example are common for the production of furniture parts comprising wooden materials or photovoltaic modules.

In a method of the present type the insertion of the core into the press and/or the placement thereof onto the bottom of the press is problematic. This may also occur outside the actual press, if applicable. Here, a “bottom of the press” in the sense of the present invention is considered any part, against which the core and/or the source material for the part to be produced is pressed by the membrane. Thus, it may also represent a mold placed on a table and inserted with it into the press, and the like. It is only important that the “bottom of the press” during the actual pressing process forms a counter-surface for the press membrane.

When the core is not placed upon the bottom of the press itself (which is only possible in a manual or computer-aided operation, as suggested for example in DE 10 2010 015 199 A1), it is very difficult to bring the core from the location the roving was placed at to the bottom of the press and to lay it thereupon without here the individual roving section shifting and in particular unintended gaps developing or roving sections becoming located over top of each other unintentionally, which due to the here generated curvatures may compromise their tensile strength. To the extent the surface of the bottom of the press is not planar but formed three-dimensionally the problem of any unintended shifting of individual roving sections is even enhanced.

### SUMMARY

The present invention is therefore based on the objective of providing a method and a removal tool of the type mentioned at the outset which can serve to automatically insert a core of rovings into a press without suffering any loss in quality.

This objective is attained in a method as well as a removal tool with one or more of the features of the invention. Preferred embodiments of the method according to the invention as well as advantageous further developments of the removal tool according to the invention are described below and in the claims.

According to the present invention the core is therefore picked up by the removal tool, at which an elastic membrane is fastened, by which the core is placed upon the bottom of the press. The elastic membrane can also adjust in a flexible manner to a three-dimensional press bottom and this way place the core of rovings onto the bottom of the press without here it needs to be feared that the rovings shift.

The membrane may be stretched over the bottom of the press when placing down the core; however within the scope of the present invention it is preferred for the membrane to be a part of the pressure chamber into which a pressure fluid can be introduced so that the membrane presses the core against the bottom of the press in a similar fashion as later the press membrane of the laminating press. This preferably occurs such that the core abuts the bottom of the press over its entire area and here particularly adjusts to the three-dimensional shape of the surface.

Using the removal tool according to the invention cores of most different types can be placed onto the bottom of a press for producing fiber composite parts, particularly also conventional mats from woven or meshed rovings. Using the membrane according to the invention such mats can particularly adapt to a three-dimensional surface form of the bottom of the press.

However, the invention offers particular advantages when a core of rovings must be placed upon the bottom of the press, which core being formed from one or more rovings, which is or are stretched between a plurality of pin elements. In this case it is preferred within the scope of the present invention for the removal tool to show a plurality of removal pins in order to accept the core from the pin elements and to transport it to the bottom of the press, stretched on said removal pins. However it is also possible to entrain the core by the removal tool, including the pin elements on which it is deposited, and then to deposit said core onto the bottom of the press using the elastic membrane. Here the removal pins of the removal tool may also form the pin elements for stretching the rovings and/or the core. In this case the rovings are directly stretched on the removal tool to form a core.

Here it is advantageous for the core stretched on the removal pins of the removal tool to be held stretched by the membrane, thus the membrane pressing for example centrally against the core in order to uphold the tension of the roving sections and to prevent them from shifting off the removal pins.

According to a preferred further development of the present invention the core is placed by stretching at least one roving onto a plurality of pin elements mobile in reference to each other. These pin elements may be individually mobile in reference to each other, however it is preferred for the pin elements to be allocated to a first group and a second group, which two groups can be moved in a combing motion in reference to each other. In this case, the preferably provided removal pins of the removal tools then engage the core respectively at the point where the roving is deflected about the pin elements. The pin elements are then moved towards each other, particularly in a combing motion of two pin element groups, so that the roving forming the core per se is relaxed. However, here the removal pins accept the feature of deflecting the roving so that consequently the core is stretched on the removal pins of the removal tool. The membrane provided according to the invention can here act in a supporting fashion and uphold the tension of the roving sections without the removal pins necessarily being mobile in reference to each other.

When the core is placed upon the bottom of the press said core can be stripped off the removal pins, particularly with the help of the membrane; however it is preferably provided that the core is cut off the removal pins. This occurs beneficially such that the cut follows the contour of the bottom of the press so that the rovings are not projecting beyond the finished part.

When the bottom of the press is formed three dimensionally and the core adapts to this form via the membrane according to the invention it is advantageous if the removal pins are elastic, for example spring loaded, when the rovings are pressed into a recess of the bottom of the press, for example. This way it is possible that the core can remain stretched on the removal pins until the membrane has put the core with its entire area onto the bottom of the press. In this case the rovings are always held at a certain tension until they are fixed between the membrane and the bottom of the press. Thereafter the roving and/or the core can be cut off the removal pins.

If the removal pins of the removal tool are positioned such that they follow the contour of the bottom of the press here advantageously few clippings develop or none at all. This is particularly advantageous in connection with a previous stretching of the core on mobile pin elements, which in turn are arranged approximately along the contour of the fiber composite part to be produced.

### BRIEF DESCRIPTION OF THE DRAWINGS

In the following an exemplary embodiment for a method according to the invention, in which a removal tool is used equipped according to the invention, is described in greater detail and explained based on the attached drawings. Shown are:

FIG. 1 is a schematic top view of a combing device;

FIG. 2 is a schematic, perspective view of the combing device of FIG. 1 after stretching;

FIG. 3 is a schematic top view of a modified combing device, also after stretching;

FIG. 4 is a view of a removal tool for removing the rovings from the combing device;

FIGS. 5A-5C are views showing the placement of the removed rovings onto a bottom of a press.

### DETAILED DESCRIPTION OF THE PREFERRED EMBODIMENTS

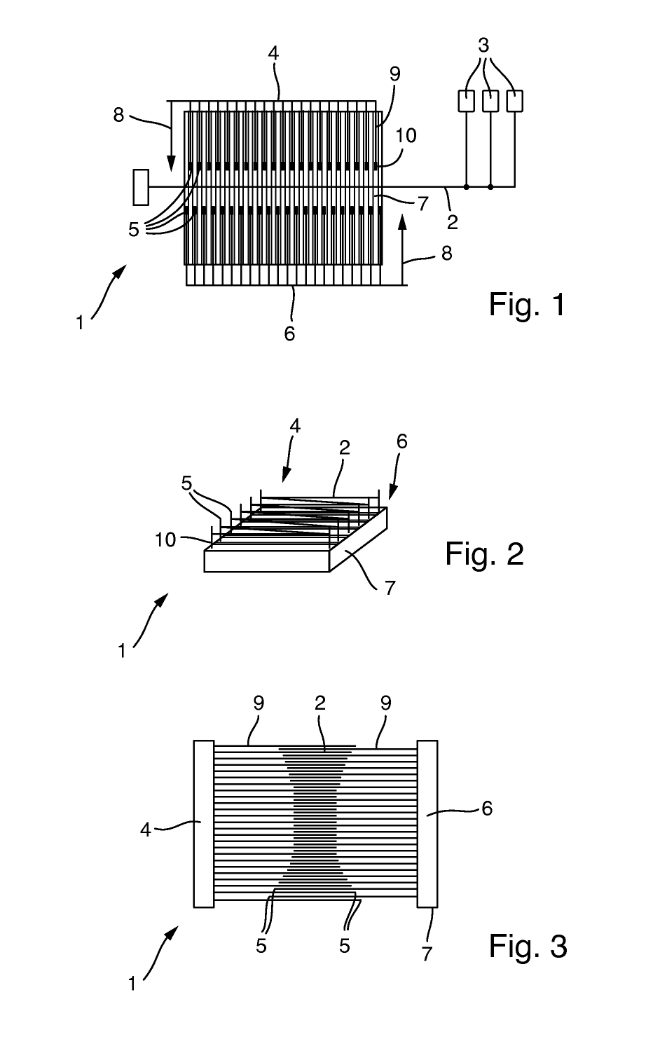

FIG. 1 shows schematically a top view of a combing device 1 for a roving 2. Strictly speaking, this roving represents a roving bundle, which comprises three coils 3, with each individual coil 3 being formed of a tape of several rovings extending parallel in reference to each other. In the present exemplary embodiment “the roving 2” therefore actually represents a bundle of several roving tapes.

The combing device 1 comprises a first group 4 of pin element 5 and a second group 6 of pin elements 5, both of which being arranged on a frame 7 in an articulate fashion. In the position shown in FIG. 1 the pin elements 5 are displaceable towards each other, engaging in a combing fashion, and in their initial position they release an area between each other into which the roving 2 is placed. Thus the roving 2 is guided between the pin elements 5 and/or between the first group 4 and the second group 6 of pin elements 5.

The directions of motion of the first (group) 4 and the second group 6 of pin elements 5 are symbolized by arrows 8, which the two groups 4, 6 must follow in order to stretch the roving 2 between each other by a combing motion of the pin elements 5. The result is shown in FIG. 2, in a schematic perspective view: The pin elements 5 of the first group 4 and the pin elements 5 of the second group 6 have been displaced in reference to each other in a combing motion, and here they have stretched between each other the roving 2 guided therebetween. This roving 2 now follows a zigzag line between the individual pin elements 5 and is deflected at each pin element 5 so that it forms a planar core layer comprising essentially identically aligned rovings.

As clearly obvious from FIGS. 1 and 2 in this exemplary embodiment of a device according to the invention one motion of the two groups 4, 6 of pin elements 5 is sufficient to lay the roving 2 to form a first planar core layer. An expensive guidance of the roving 2 about the plurality of pin elements 5, which had to occur manually or via a robot, can be waived, here.

Within the scope of the present invention the pin elements 5 may also be arranged in an entirely different fashion, of course, and be mobile in different directions. Additionally it is possible to move the pin elements 5 not in groups but individually.

FIG. 3 shows a modification of the stretching of the rovings 2 on a combing device 1 shown in principle in FIG. 2: Here, the pin elements 5 are only displaced to an individual end position so that during the stretching of the rovings 2 ultimately the developing core layer is provided with a contour which is equivalent for example to the contour of the part to be produced. When this core layer is removed from the frame 7 accordingly no clippings develop or hardly any, because the core layer no longer needs to be subsequently adjusted to the contour of the part to be produced.

The pin elements shown in FIGS. 1 to 3 each comprise pin carriers 9 and pins 10 arranged thereon, with the roving 2 being deflected around them. The pins 10 for stretching the rovings 2 can be moved by the pin carriers 9. The pins 10 are provided with conical deflection areas (not shown here), which rest on the pins 10 in a rotational fashion and thus are embodied like thimbles. The bearing allows an advantageously low friction between the roving 2 and the pin 10, while the conical area maintains the orientation of the roving 2 as a tape.

At this point it may be stated that within the scope of the present invention the pin elements may also be embodied differently, particularly as massive carriers. It is only important that the pin elements are mobile in reference to each other such that the roving guided between them can hereby be stretched between them.

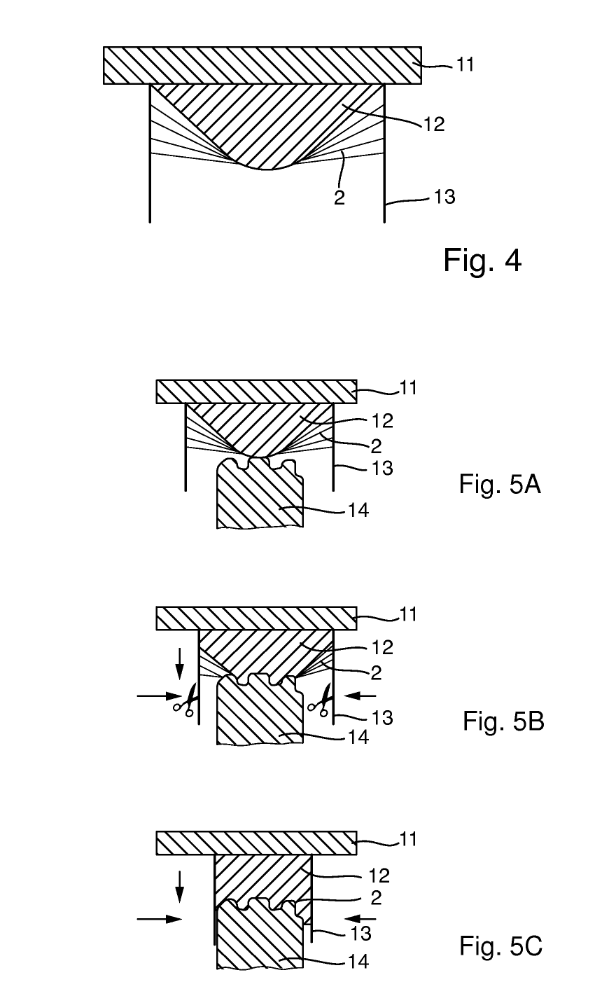

FIG. 4 shows in a schematic lateral cross-section a removal tool, which can be used to remove a core layer, stretched on the frame 7, by the combing device 1. It relates to a membrane frame 11 with a membrane 12, which can be inflated like a balloon by pressure being inserted into the membrane frame 11. The membrane frame 11 is lowered onto the combing device 1 and/or placed thereupon, with here the number of removal pins 13 being arranged like the pin elements of the combing device 1. After the membrane 11 has been lowered the roving 2 is stripped off by a movement of the two groups 4, 5, 6 of pin elements 5 towards each other to the removal pins 13 and the membrane 12 is inflated so that the roving core layer is fixed in its position.

This way, the core layer as shown in FIG. 5 is then transferred to a bottom 14 of a press and placed there, with the bottom 14 of the press particularly showing the three-dimensional surface which later shall be embodied by the fiber composite part to be produced. The bottom 14 of the press, strictly speaking, is only a negative form of the part to be produced, which is located outside the actual press and here can be provided with the core and the matrix material. Thereafter this form is inserted into the actual press, with here during the pressing process it then represents the bottom of the press, seen by the part to be formed, against which the part is pressed by the press membrane.

As already mentioned, the removal tool can simultaneously act as the combing device within the scope of the present invention. This would result in a design such that the combing device 1 shown in FIGS. 1 to 3 is additionally provided with a membrane 12 by which the rovings 2 stretched on the combing device 1 can be placed onto the bottom 14 of the press.

As shown in FIGS. 5A-5C in three consecutive processing steps, the membrane 12 is lowered with the membrane frame 11 and the core of rovings 2 onto the bottom 14 of the press, with initially the membrane 12 centrally adapting to the contour of the bottom 14 of the press and the rovings 2 being fixed here (FIG. 5A). The membrane 12 is then further inflated or further lowered so that the core of rovings 2 is pressed into two recesses discernible here (FIG. 5B). This way the removal pins 13 are pulled towards the center and/or the bottom of the press, which in the present exemplary embodiment is possible because the removal pins 13 rest in the membrane frame 11 in a spring-loaded, articulate fashion. After the rovings 2 have been cut off the removal pins 13 of the removal tool (FIG. 5B) the membrane 12 is further inflated so that it completely adapts to the bottom of the press and the first core layer of rovings 2 is placed here in the desired three-dimensional form (FIG. 5C).

A repetition of the stretching of a core layer, the removal thereof, and the placement onto the bottom 14 of the press in different alignments, if applicable, then allows several core layers to be generated in the desired three-dimensional form over top of each other, which then are already positioned in the bottom 14 of the press. For example after dispersing a matrix material subsequently the finished fiber composite part can be produced automatically in a laminating press under the influence of heat and pressure.

In particular when several core layers are placed upon the bottom 14 of the press it is advantageous for the individual core layers to be preliminarily fixed on said bottom 14 of the press using an adhesive, vacuum, electrostatic forces, or the like.

1. A method for inserting cores of rovings (2) into a press, in which fiber composite parts are produced, comprising: receiving the core with a removing tool (11, 12, 13), moved over a bottom (14) of the press, and placing the core on the bottom of the press occurs with an elastic membrane (12) fastened to the removal tool.

2. The method according to claim 1, further comprising introducing a pressure fluid into a pressure chamber, at least partially abutting the membrane (12), so that the membrane (12) presses the core against the bottom (14) of the press.

3. The method according to claim 2, further comprising the membrane (12) forcing the core to adapt over an entire area against the bottom (14) of the press.

4. The method according to claim 3, further comprising fixing the core on the bottom (14) of the press.

5. The method according to claim 4, further comprising placing the core by stretching at least one roving (2) on a plurality of pin elements (5), mobile in reference to each other, and removing the core stretched in this way via removal pins (13) of the removal tool off the pin elements (5) by the removal pins (13) engaging the core at a location where the rovings (2) are deflected about the pin elements (5), and then the pin elements (5) are moved such that the roving (2) thereafter is stretched on the removal pins (13) of the removal tool.

6. The method according to claim 5, wherein the core is placed by stretching the at least one roving (2) on a plurality of pin elements (5), mobile in reference to each other, which form a first group (4) of pin elements (5) and a second group (6) of pin elements (5), which can be moved in reference to each other in a combing motion.

7. The method according to claim 5, wherein the core, stretched on the removal pins (13) of the removal tool, is held stretched via the membrane (12).

8. The method according to claim 5, wherein the roving (2), during or after the placement of the core on the bottom (14) of the press, is cut off the removal pins (13).

9. The method according to claim 1, wherein the core is placed by stretching at least one roving (2) on a plurality of pin elements (5), mobile in reference to each other, and a removal tool is used with removal pins (13), with the removal pins (13) being used as the mobile pin elements (5) for placing the core.

10. A removal tool for implementing the method according to at least one of claim 1, wherein the removal tool includes the elastic membrane (12) for placing the core onto the bottom (14) of the press.

11. The removal tool according to claim 10, further comprising a pressure chamber (11), which is limited at least partially by the membrane (12) and into which pressure fluid can be introduced.

12. A removal tool according to claim 10, further comprising a plurality of removal pins (13) to stretch the core.
